(19) United States
(12) Patent Application Publication
(10) Pub. No.: US 2009/0217952 A1
(43) Pub. Date: Sep. 3, 2009

(54) Paint Brush Cleaner

(76) Inventor: David William Moar, Feilding (NZ)

Correspondence Address: SHERIDAN ROSS PC, 1560 BROADWAY, SUITE 1200, DENVER, CO, 80202, US

(21) Appl. No.: 12/223,002

(22) PCT Filed: Jan. 18, 2007
(86) PCT No.: PCT/GB2007/000166

§ 371 Date: Jan. 12, 2009

(30) Foreign Application Priority Data
Jan. 20, 2006 (NZ) 544809

(51) Int. Cl. B08B 3/02

(52) U.S. Cl. 134/38; 134/198

(57) ABSTRACT

The present invention relates to a paint brush cleaner including an open ended cover (10) into which a paint brush (B) can be inserted handle end first. A connector (13) is provided for connection to a source of cleaning fluid. The paint brush cleaner is also provided with means for directing cleaning fluid from the connector (13) into the interior of the cover (10). In use, cleaning fluid can flow over the bristles of a brush (B) from the handle end thereof. The present invention also relates to a method of cleaning a brush.

The present invention relates to a brush cleaner. The brush cleaner according to the present invention has particular application for the washing of brushes that have been used in water based paints.

A continual problem which faces not only professional painters but also DIY painters is the removal of paint from the paint brush at the completion of a painting operation. Because the washing of paint brushes is often seen as a chore paint brushes are often not cleaned or not cleaned adequately at the completion of a painting job. One of the reasons why the cleaning of a paint brush is seen as a chore is that it is a somewhat messy operation and it is time consuming to remove all trace of paint from the paint brush, especially when the paint brush is to be reused with different coloured paint.

It is therefore an object at least in preferred embodiments of the present invention to provide a paint brush cleaner that can be readily used to remove paint from a paint brush in an effective and efficient operation.

It is a further object at least in preferred embodiments of the present invention to provide a paint brush cleaner that is readily adaptable to different sizes of paint brushes within a limited size range.

Broadly according to one aspect of the invention there is provided a paint brush cleaner including an open ended cover into which a paint brush can be inserted handle end first, a connector for connection to a source of cleaning fluid, and means for directing cleaning fluid from the connector into the interior of the cover whereby in use cleaning fluid can flow over the bristles of a brush from the handle end thereof.

In a preferred form of the invention a part of the cover opposite to the open end includes an aperture through which the handle of the brush can project.

In a preferred form, the directing means includes a pressure chamber into which the connector opens, there being one or more openings from the pressure chamber into the interior of the cover by way of which cleaning fluid can pass from the pressure chamber into the interior of the cover.

Preferably the connector is a part of quick release hose coupling and the source of cleaning fluid is a mains water supply.

According to a preferred form of the invention the cover includes a wall which is moveable to accommodate different widths of paint brush in the cover.

Preferably the wall is coupled to force applying means which forces the movable wall to at least in part be forced into contact with part of a brush when located in the cover to hold the brush in the cleaner.

In a preferred embodiment the cover includes an openable portion to assist in the insertion/release of a brush from the cover. The openable position can be a zip-fastener closable slit in a wall of the cover.

A sealing member is preferably provided for cooperating with a handle of the paint brush. In use, the sealing member may form at least a partial seal with the handle to help reduce or prevent the escape of cleaning fluid around the handle. The sealing member may be an O-ring or a flexible member.

The cover may have a substantially uniform transverse cross-section. Preferably, however, the cover is tapered. The cover is preferably tapered inwardly towards the open end thereof. Alternatively or in addition, an inwardly directed flange may be provided on the cover. The flange may be provided at the open end of the cover.

The cover may be waisted. In other words, the cover may have a tapered waist.

The paint brush cleaner according to the present invention may be provided with a hanger. The hanger is preferably a hook.

The paint brush cleaner according to the present invention thus provides a method of cleaning a paint brush wherein the paint brush is inserted handle first into the cleaner device, water is applied to the cleaning device and directed substantially as a curtain of water over the bristles and thereby creating a vacuum or vacuum effect to draw out of the bristles paint resident therein.

Viewed from a further aspect, the present invention relates to a brush cleaner comprising a connector for connection to a source of cleaning fluid and a cover for receiving. at least a portion of a brush; wherein, in use, cleaning fluid introduced through the connector flows over the bristles of the brush, the cleaning fluid flowing substantially from the base of the bristles to the tips thereof.

The brush cleaner is preferably provided with a movable member. In use, the movable. member is preferably co-operable with a brush provided in the brush cleaner. The movable member may thereby help retain the brush in position in the cleaner. The movable member is preferably a movable wall.

Preferably, means are provided for displacing the movable member. At least part of the movable member is preferably displaceable into the interior of the cover. The displacement means is preferably actuatable by the introduction of cleaning fluid into the brush cleaner. The displacement means may comprise a resilient member in fluid communication with the connector. The resilient member may define a portion of a side wall of a chamber into which the cleaning fluid is introduced.

The cleaning fluid introduced through the connector preferably enters an interior of the cover. An outlet is preferably provided for allowing cleaning fluid to exit the brush cleaner. The outlet may be an aperture or a nozzle. Alternatively, the cover may be open ended.

Preferably, the cover at least partially covers the bristles of a brush located in the cleaner. The cover preferably forms a skirt. The skirt preferably extends around at least part of the bristles.

Viewed from a further aspect, the present invention relates to a method of cleaning a brush using a cleaner as described herein, wherein the brush is located into the cleaner and a cleaning fluid is introduced into the cleaner through the connector.

The cleaning fluid is preferably water. Most preferably, the water is supplied from a mains supply, such as a tap.

In the following more detailed description of the invention according to a preferred embodiment reference will be made to the accompanying drawings in which:

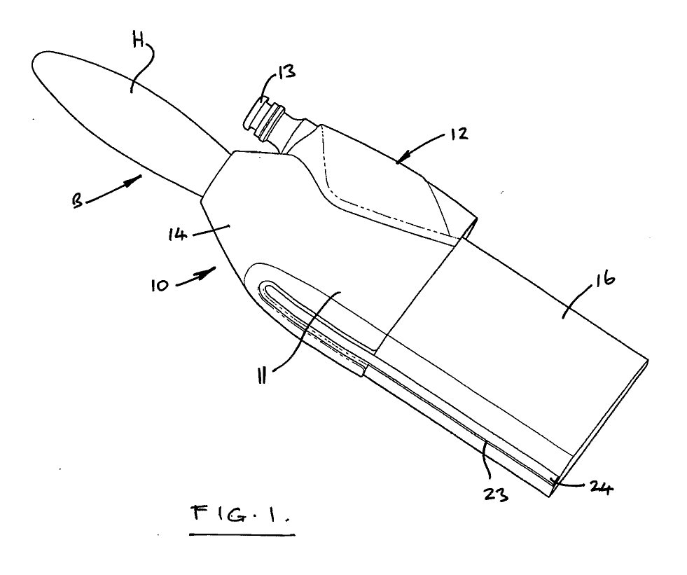

FIG. 1 is a perspective illustration of the paint brush cleaner according to the preferred embodiment with a paint brush in place,

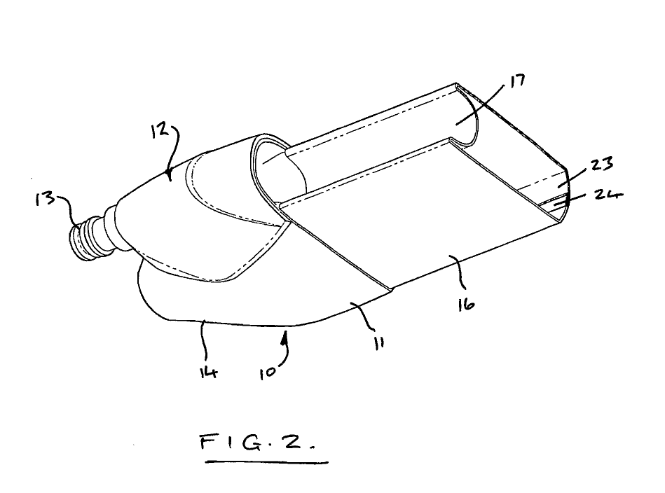

FIG. 2 is a further perspective view of the paint brush cleaner of FIG. 1,

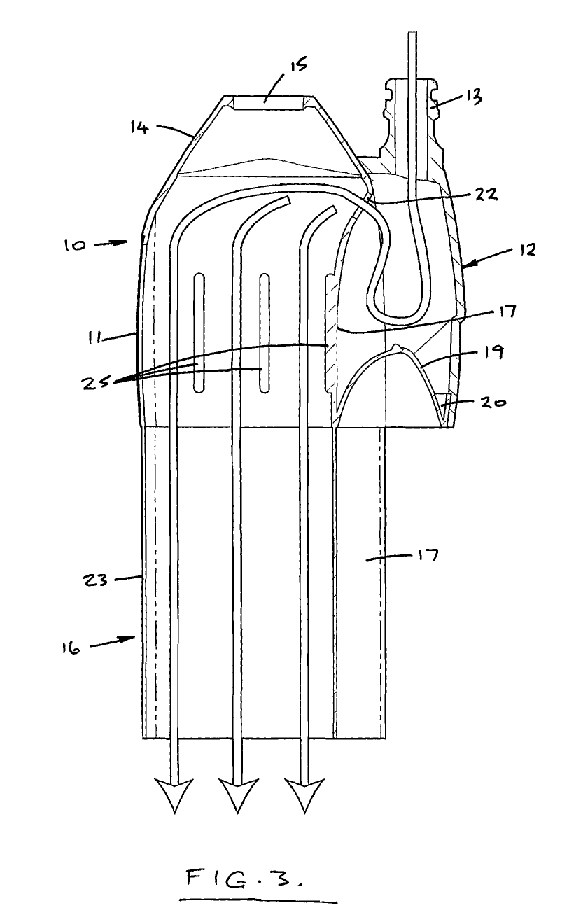

FIG. 3 is a cut away illustration of the paint brush cleaner showing not only the internal construction of the cleaner but also the direction of flow of cleaning fluid (water) through the cleaner, and

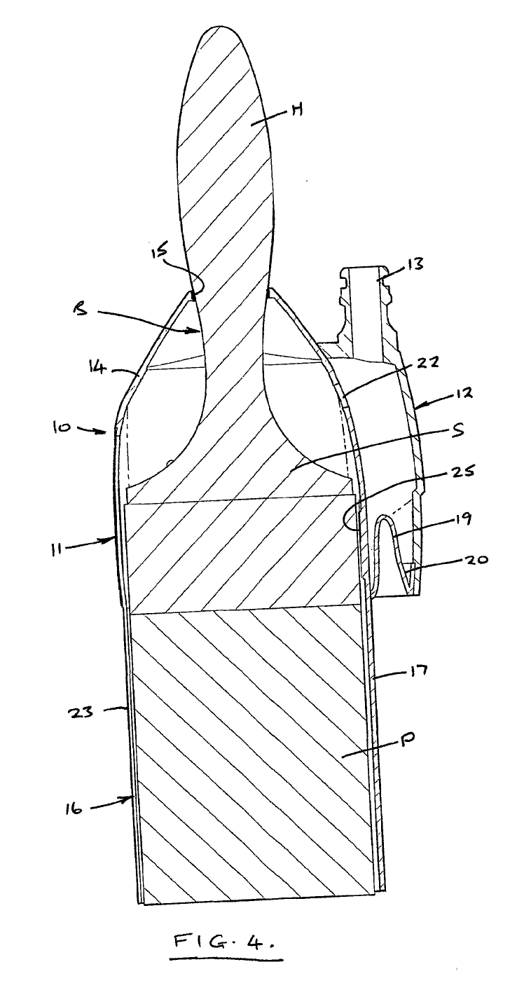

FIG. 4 is a further cut away illustration showing a paint brush in place in the cleaner.

The following is a more detailed description of the preferred form of the paint brush cleaner as shown in the drawings. According to this form of the invention the cleaner includes an open ended cover 10 which includes a body 11 to which is attached a housing 12 that is attached to, or incorporates a hose connector 13. This hose connector 13 is of conventional construction whereby it can clip fit into a conventional quick release coupling device of a domestic hose.

The cover 10 has at one end (which will, normally in use, be uppermost when the cleaner is in its in-use orientation) a top cover portion 14. This top cover 14 is coupled to body 11 and includes an opening 15 through which the handle H of a paint brush B (see FIG. 4) can be inserted. The end of the handle H can thus project from the top cover portion 14.

In the preferred form of the invention cover 14 will be of a flexible construction so that the size and shape of the opening 15 can vary to allow for different handle sizes. It is preferred that the cover 14 with its associated opening 15 encircle the handle H of the brush B so as to provide a more or less sealed fit about the periphery of the handle H. It will be appreciated by those skilled in the art that other means of sealing about the peripheral surface of the handle H can be employed.

In one preferred form of the invention (though not illustrated) the cover 14 can include a tab/grip means so as to make the process of removing the brush cleaner from the brush easier at the completion of a cleaning operation. This tab/grip vent can be formed in different ways though, in one form, the tab/grip is joined to the cover 14 close to the proximity of the parameter of the opening 15 with sufficient surface area for the user to grasp with thumb and forefinger(s). In this way the user can hold the cover 14 against any tendency for the cover 14 to invert and make difficult removal of the brush from the cleaner device.

Other means of forming a grip to facilitate removal of the paint brush cleaner from the brush can be provided.

The cover 10 is completed by a skirt 16 which extends from the lower open end of the body 11. As can be seen in FIG. 4, this skirt engages about the bristle portion P of the brush B.

As shown in the drawings the skirt 16 includes, along one edge thereof an inwardly curved wall 17. This wall 17 extends as a continuation of a similarly curved part 18 of the body 11. A curved transitional wall 19 extends from the upper end of the curved wall 17 to have a return portion 20 thereof coupled to a lower wall part 21 of the housing 12. This transitional wall 19 is, as with curved wall 17, resilient and, therefore, able to deform/flex as will hereinafter become apparent.

The wall part 17 of the body 11 includes, near its upper end (i.e. where it joins with the cover 14), an aperture or a plurality of apertures 22. The situation of aperture(s) 22 directs water, as shown in FIG. 3, across the upper part of body 11 and the water then flows down (directed by ribs 25) as hereinafter described.

To enable a brush B to be installed in the cover 10 the sidewall 23, which is opposite to curved wall 17, includes a means for opening up longitudinally part or all of the length of the wall 23. This assists in the installation/removal of a brush from cover 10.

In one form of the invention this opening means can be in the form of an open end slit formed in the sidewall 23 of cover 10. The slit can be closed by a zip fastener 24. Thus, a user can move the zip slider (not shown) from the lower distal end of the skirt 16 to open up the skirt 16 so as to make it easier to fit a brush by inserting the handle end of the brush through the confines of the skirt 16, the body 11, top cover portion 14, and through the opening 15.

As shown in FIG. 4 when the brush B is located in the cover 10, the handle H extends through the opening 15, the shoulder portions S of the brush is located within the body 11 and the bristle portion P of the brush is located within the skirt 16.

The slit/zip-fastener can extend up the cover as far as maybe desired. For example in one embodiment the slit/zip-fastener extends up into the upper region of body 11.

Because the curved wall 17 is able to move back and forth (this being permitted by the deformable nature of the wall 17 and transitional wall 19), the wall 17 can move in or out to adjust to the width of the brush fitted into the cleaner 10. In this way the cover 10 can be readily self adjusting to fit snugly with brushes of varying sizes within a determined size range.

In a preferred form of the invention the walls of the body 11 are provided with longitudinally extending ribs 25. These ribs 25 can provide a desired degree of stiffening to the body 11 as well as provide gripping surfaces to grip against the shoulder portion S of a brush when inserted in the body 11. The intention of the gripping effect thus formed helps hold the brush against the force of water flowing in the cleaner. The ribs 25 also have the effect of directing the water as described herein.

Once the brush has been installed in cover 10 the zip-fastener 24 is reinstated to its closed position. Thus, with a hose (not shown) connected from a normal mains water supply to the hose connector 13, water can enter a pressure chamber 26 formed by housing 17. The water can flow therefrom through the, or each of the, apertures 22 and into the interior of the cover 10.

When water is first introduced it pressurises the pressure chamber 26 and in doing so applies pressure to the transitional wall 19 and the sidewall 11a of the body 11 so as to cause sidewall 17 to adjust the cleaner to the size of the brush. The water that has passed from the pressure chamber 26, through the apertures 22 then flows through the cover 10 to form a substantially uniform curtain of water, which flows down over the shoulder portion S and through the bristle portion P within the skirt 16. The water with entrained paint then flows out the open bottom of the skirt 16.

The largely uniform flow of water or curtain of water thus applies a cleaning action to the bristles of the brush. The flow of water through the cleaner 10 can continue until such time as the water exiting the cleaner is substantially clear thereby indicating removal of paint from the bristles of the brush. At this point the flow of water into the cleaner 10 can be discontinued and the brush then removed. To facilitate brush removal the zip-fastener can be moved to its open position.

The process of removing paint from the paint brush bristles is facilitated by a vacuum which may be created within the cleaner, this vacuum drawing out paint from within the bristles. The uniform curtain of water provided by the ribs 25 create this vacuum or vacuum like effect to draw paint from within the paint brush bristles.

In a preferred form of the invention the body 11, top cover portion 14 and skirt 16, as well as the transitional wall 19 can be of unitary construction. The method of manufacture may be such that different portions of the construction have different wall thickness, i.e. the skirt 16 may be of less wall thickness than the thickness of the wall of the body 11. The housing 12 can be formed, e.g. by plastic moulding, of a semi-rigid material as a separate item which is fixed to the body 11 with the return portion 20 adhered or otherwise fixed to the lower part of the housing 12.

It will, nevertheless, be appreciated by those skilled in the art that parts of the cleaner can be constructed separately and the parts then joined together to complete the finished construction. Also, the degree of flexibility of the top portion 14, body 11 and skirt 16 can be selected as may be required to achieve the desired end result.

The invention is open to modification as will be apparent to those skilled in the art. For example, one modification is the provision of a tab/grip in the cover 14, as previously described. In another modification the sidewall 23 of the skirt 16 could slope inwardly from its upper to lower ends, i.e. converge toward the moveable wall 17.

The paint brush cleaner according to the present invention thus provides a cleaner device into which a paint brush can be readily installed handle first. Water can thus be directed to flow through the cleaner so as to remove paint from the bristle portion of the brush and the water with entrained paint issued in a controlled manner from the open end of the cleaner. The manner in which the water flows through the cleaner and creates the vacuum or vacuum like effect to draw paint from within the paint brush bristles and the fact that it is retained in close contact with the bristle portion of the brush, provides for a good and efficient cleaning action. Also, the retaining of the water flow within the cleaner and a single controlled outlet flow ensures that the creation of any mess is kept to any minimum.

The cleaning ability of the paint brush cleaner can be accelerated by the user. For example, the user can hold the paint brush cleaner in one hand and then by use of the other hand apply an agitating or manipulating action to the skirt 16 so as to increase the penetration of the water into the bristles and thereby speed up the process. It will be appreciated. that this manipulation of the bristles does not involve the user actually coming in contact with the bristles and thereby having the paint being washed from the brush come in contact with the user's hand.

This manipulation of the bristles might be best carried out in a tub, container or the like during the cleaner being in operation. By confining the activity to a tub or the like, the likelihood of the area immediately adjacent the cleaning operation being messed up, is reduced.

Thus, for example, the cleaner can be used in conjunction with a sump into which the water issuing from the cleaner can be directed. This sump may, for example, be a drain or it could be a container of sufficient volume to receive and retain the outflow of paint laden water from the cleaner.

Preferably, the construction is such that automatic adjustment to the size of the brush fitted into the cleaner will occur upon the brush being installed and preferably upon water being supplied to the pressure chamber 26.

It will be appreciated that various changes and modifications may be made to the preferred embodiment described herein without departing from the spirit or scope of the invention.

Although the present invention has been described with particular reference to paint brushes, it will be appreciated that the invention may be used for cleaning other types of brush. For example, the invention could be used to clean a wallpaper paste brush or the like.

What is claimed is:

1. A paint brush cleaner comprising:
an open ended cover into which a paint brush can be inserted handle end first,
a connector for connection to a source of cleaning fluid, and
means for directing cleaning fluid from the connector into an interior of the cover whereby in use cleaning fluid can flow over bristles of a paint brush from a handle end thereof.

2. A paint brush cleaner as claimed in claim 1, wherein a part of the cover opposite to the open end includes an aperture through which the handle of the paint brush can project.

3. A paint brush cleaner as claimed in claim 1, further comprising a pressure chamber.

4. A paint brush cleaner as claimed in claim 3, wherein the cover defines one or more openings from the pressure chamber into the interior of the cover by way of which cleaning fluid can pass from the pressure chamber into the interior of the cover.

5-6. (canceled)

7. A paint brush cleaner as claimed in claim 1 further comprising:
a moveable wall, and
biasing means for biasing at least part of the movable wall against a paint brush when located in the cover.

8. (canceled)

9. A paint brush cleaner as claimed in claim 7, wherein said biasing means is actuatable by a pressure of the cleaning fluid introduced through the connector.

10. A paint brush cleaner as claimed in claim 7, wherein said biasing means comprises a resilient member in fluid communication with the connector.

11. A paint brush cleaner as claimed in claim 1, wherein the cover includes an openable portion.

12. (canceled)

13. A paint brush cleaner as claimed in claim 1, further comprising a sealing member co-operable with a handle of a paint brush.

14. A paint brush cleaner as claimed in claim 1, wherein the cover is tapered.

15-19. (canceled)

20. A brush cleaner comprising:
a connector for connection to a source of cleaning fluid; and
a cover for receiving at least a portion of a brush;
wherein, in use, cleaning fluid introduced through the connector flows over bristles of the brush, the cleaning fluid flowing substantially from a base of the bristles to tips thereof.

21. A brush cleaner as claimed in claim 20, further comprising:
a movable member; and
displacing means for displacing the movable member.

22. (canceled)

23. A brush cleaner as claimed in claim 21, wherein said displacing means is actuatable by introduction of cleaning fluid into the connector.

24. A brush cleaner as claimed in claim 21, wherein said displacing means comprises a resilient member in fluid communication with the connector.

25. A method for cleaning a brush comprising:
locating the brush in a brush cleaner that includes a connector for connection to a source of cleaning fluid and a cover for receiving at least a portion of the brush; and
introducing the cleaning fluid through the connector such that the cleaning fluid flows over bristles of the brush substantially from a base of the bristles to tips thereof.
